(19) United States
(12) Patent Application Publication
(10) Pub. No.: US 2013/0018975 A1
(43) Pub. Date: Jan. 17, 2013

(54) LOW FREQUENCY METHOD OF PAIRING A MASTER DEVICE TO MULTIPLE SLAVE DEVICES

(71) Applicant: Robert J. Higgins, Plantation, FL (US)

(72) Inventor: Robert J. Higgins, Plantation, FL (US)

(73) Assignee: MOTOROLA SOLUTIONS, INC., SCHAUMBURG, IL (US)

(21) Appl. No.: 13/183,930

(22) Filed: Jul. 15, 2011

(51) Int. Cl. G06F 15/16

(52) U.S. Cl. 709/208

(57) ABSTRACT

Method and apparatuses for pairing more than one slave device with a master device through an exchange of low frequency messages between the slave devices and the master device are disclosed. A first secure data connection is established between a first slave device and the master device typically upon successfully completing a low frequency exchange of pairing credentials associated with establishment of the first secure data connection. The first slave device maintains an active, low frequency transceiver for receiving low frequency transaction requests from other slave devices. Upon receipt of a low frequency transaction request from a second slave device, the first slave device forwards low frequency transmissions between the second slave device and the master device to facilitate in exchanging pairing credentials associated with establishment of a second secure data connection.

### FIELD OF THE DISCLOSURE

The present disclosure relates generally to pairing communication devices and more particularly to providing a low frequency method of pairing multiple slave devices to a master device without requiring direct low frequency pairing between each slave device and the master device.

### BACKGROUND

Pairing is a process in which two devices communicate with each other through an established connection, and by exchanging information (credentials), the devices build a trusted relationship and share a secret useful for future communications security. In, for example, “star topology” systems, one of the paired devices, for example a radio, is considered to be a master device and the other paired device, for example an accessory such as a headset, is considered to be a slave device. The master device may pair with and be simultaneously connected to multiple slave devices and the master device manages the established connection with each slave device. Therefore, the master device is configured to maintain a list of credentials being used by paired slave devices. In star topology communications systems, all communications from the slave devices are directed to the center of the star topology; that is, all communications from the slave devices are directed to the master device.

Using a low frequency pairing technology, during the pairing process, the master and slave devices are paired by basically “touching” (placing in close physical proximity) the slave device to the master device. In particular, during the pairing process, all slave devices to be paired with the master device must “touch” (be placed in close physical proximity to) a touch-point on the master device. The touch-point is a point on the master device that is capable of low frequency transactions with slave devices. Low frequency communications are desirable for the master/slave communications at a touch-point because low frequency implies long wavelength. At low frequencies, antenna-like wave coupling structures are designed that interact using a modulated evanescent field whose amplitude declines in a smooth exponential manner from the source. A common frequency for low frequency communications is 125 kilo-Hertz (kHz) having a corresponding free space wavelength of 7,869 feet. With typical touch-point coupling structure dimensions of one quarter of an inch, the structure would be 2.6E-6 (2.6 millionths) of a free space wavelength—a very small fraction. At such a small fraction a wavelength, the antenna-like coupling structure will have negligible interaction with propagating radio signals and will utilize only evanescent fields. The modulated evanescent field coupling to the companion device falls rapidly with separation, providing security from surreptitious detection by unseen attackers. Therefore, in touching the slave device to the master device, a modulated low frequency evanescent field (typically magnetic) is used to transfer security parameters (pairing credentials) needed for the slave device to connect to the master device via a longer range primary Radio Frequency (RF), propagating communications means. This low frequency transaction may take place over a range, for example of only two inches, providing privacy for the exchange and eliminating man-in-the-middle (MITM) attacks.

The master device maintains the security policy for establishing connections with slave devices, and upon receiving a low frequency transaction request from a slave device, the master device decides if pairing credentials are to be exchanged with the slave device. The transaction between the master device and slave devices is typically hidden from a user of the master and slave devices. For pairing a single slave device with the master device, this is an improvement over prior art pairing via Bluetooth which requires the user to enter a pass code in order to pair devices securely. This low frequency pairing works securely and easily even when neither the master device nor the slave device has a keypad or display.

Master devices, such as portable or mobile radios, are designed to support multiple simultaneous connections with slave devices. For example, in operation, a portable or mobile radio could have simultaneous connections to sensors, one or more wireless push-to-talk devices, a headset, and a collaborating mobile computer. However, as multiple slave devices are to be connected with one master device, the touch pairing process may become burdensome. For example, in order to establish a connection between a radio and a headset, the headset is paired with the radio when the headset is placed in close physical contact with the touch-point on the radio during the pairing process. After the devices are paired and the primary communications link is formed using the credentials, during use, the radio may be placed in a protective housing, such as a holster or pocket. In order to pair another accessory with the radio, the radio may have to be removed from the protective housing in order for additional accessories to be placed in close physical contact with the touch-point on the radio. If, for example, the radio is a large portable radio that is not easily removed from its housing, or if the radio is kept in an inconvenient location (such as a fireman's turnout coat pocket, or placed in a bag that is mounted on an emergency personnel back), or if the radio is a mobile radio in an emergency vehicle that is located out of the “touching” range, the touch pairing process between the radio and additional accessories may be inconvenient after the radio is stored.

The master device manages connection establishment with each slave device and is the sole security manager for each connection with a paired slave device. Therefore, the master device is configured to grant access parameters to each allowed slave device during pairing. While this centralized authority for connection authorization is desirable, as noted above, the master only dispenses pairing credentials to slave devices via touch pairing each slave device with the master device. In instances where a slave device cannot be easily touch paired with the master device, there is no simple method for securely exchanging pairing credentials between the master and slave devices.

Accordingly, there is a need for a method and apparatus for pairing multiple slave devices to the master device without requiring that each slave device be placed in close physical contact with the touch-point on the master device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of communication devices operating in accordance with some embodiments.

FIG. 2 is a block diagram of a configuration of a paired communication devices in accordance with some embodiments.

FIG. 3 is a message sequence chart illustrating the operation of a first slave device assisting in the pairing of a second slave device with a master device in accordance with some embodiments.

FIG. 4 is a block diagram of components of a master device used in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to method and apparatuses for pairing more than one slave device with a master device through an exchange of low frequency messages between the slave devices and the master device. Upon successfully completing a low frequency exchange of pairing credentials between the master device and a first slave device, a first secure data radio frequency (RF) connection is established between the first slave device and the master device. In accordance with an embodiment, the first slave device maintains an active, low frequency transceiver for low frequency communications with other slave devices. Upon receipt of a low frequency transaction request from a second slave device, the first slave device forwards received low frequency data to the master device via the first slave device's secure data RF connection to the master device. The master device recognizes the data from the first slave as a remote pairing attempt, composes a reply to the second device, and sends the reply to first slave device over the first slave device's secure data RF connection with the master device. The reply includes a data wrapper for indicating that the reply is a low frequency reply to the second slave device. When the first slave device receives the wrapped message from the master device, the contents of the message are transmitted over first slave device's low frequency transmitter to second slave device. This back and forth low frequency message exchange between the second slave device and the master continues, via the first slave device as a proxy, until a complete pairing credential exchange has occurred between the master device and the second slave device. Upon successfully completing the exchange of pairing credentials between the second slave device and the master device a primary radio frequency secure data RF connection is established directly between the second slave device and the master device.

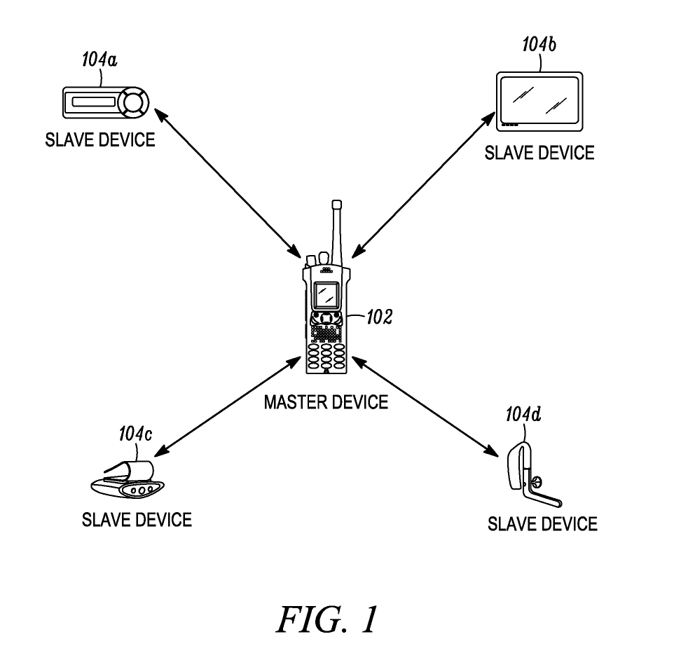

FIG. 1 is a block diagram of communication devices operating in accordance with some embodiments. The communication devices include a master device 102 and slave devices 104a-104d. The master device may be, for example, a mobile radio, a portable radio, and the like. Slave devices 104a-104d may be, for example, sensors, wireless push-to-talk devices, a headset, a mobile computer or other accessories that may be operated wirelessly with the master device. Master device 102 is configured to permit simultaneous-communication connections with more than one slave device. In the configuration shown in FIG. 1, once master device 102 is paired with slave devices 104a-104d all communications from each slave device are transacted directly with master device 102.

Master device 102 maintains a security policy for authorizing connections with slave devices 104a-104d. In other words, master device 102 has responsibility for deciding which slave devices are allowed to become a part of a system of communicating devices. Each of the master device 102 and slave devices 104a-104d includes a low frequency transceiver for exchanging information during the pairing process. The low frequency transceiver on each of the master device 102 and slave devices 104a-104d also includes a touch-point, a point on each device 102 and 104 that is used to optimize proximity for transception of low frequency communications. In order to pair a slave device, for example slave device 104a, with master device 102, a transaction request is sent repetitively from the low frequency transmitter on slave device 104a. When slave device 104a is placed within a short range of the touch-point of master device 102 (for example up to two inches), the low frequency receiver within master device 102 receives the transaction request from slave device 104a. Upon determining by master device 102 that slave device 104a is acceptable within its security policy by examination of slave device 104a's transaction request, master device 102 and slave device 104a exchange, via low frequency transception, additional security parameters that are required for a primary RF connection establishment, thus “pairing” master device 102 and slave device 104a. Once master device 102 is paired with slave device 104a, a primary secure data RF connection is established between master device 102 and slave device 104a over a wider area RF wireless means. The wider area secure wireless RF connection may be, for example, a Bluetooth connection between master device 102 and slave device 104a that may be securely encrypted by standard Bluetooth means.

In the current art, upon pairing master device 102 with slave device 104a, the low frequency transceiver on slave device 104a has no further function until pairing is again required for slave device 104a. In an embodiment disclosed herein, the low frequency transceiver on slave device 104a remains active after it is paired with master device 102. Thereafter, slave device 104a, once linked to master device 102 via a wide area secure wireless RF connection, is configured to be a digital repeater (or router) for low frequency pairing exchanges between master device 102 and other slave devices. In other words, the active low frequency transceiver on slave device 104a is configured to “listen” for low frequency transaction requests that are being transmitted from other slave devices, and upon receiving these, slave device 104a will forward the transaction requests to the master device over slave device 104a′s wide area secure wireless connection with master device 102.

When slave device 104a receives low frequency transmissions from another slave device, for example slave device 104b wishing to become paired to master device 102, slave device 104a wraps the received low frequency data packets with a low frequency identifier and forwards the wrapped data packets to master device 102 over the wide area secure wireless RF connection between master device 102 and slave device 104a. The low frequency identifier may be a predefined set of characters that are appended to the beginning and/or end of the low frequency packets. Master device 102, recognizing the low frequency data wrapper, receives the data packet as though it had come from its own low frequency transceiver. Master device 102 forms a low frequency reply, wraps it with the low frequency identifier, and returns the low frequency reply to slave device 104a, via the wide area secure wireless RF connection established between master device 102 and slave device 104a. Slave device 104a removes the wrapper from the data received from master device 102 and transmits the low frequency reply received from master device 102 to slave device 104b over the low frequency transmitter on slave device 104a. Using this process, master device 102 and slave device 104b may exchange pairing credentials that are required for subsequent connection establishment. Upon successfully completing the exchange of pairing credentials in this manner, a separate wide area secure wireless RF connection is established directly between master device 102 and slave device 104b. Hence, once a first slave device (in this example slave device 104a) is connected to the master device, a second slave device (in this example slave device 104b) can become paired with the master device by simply touching the touch-point of the first slave device.

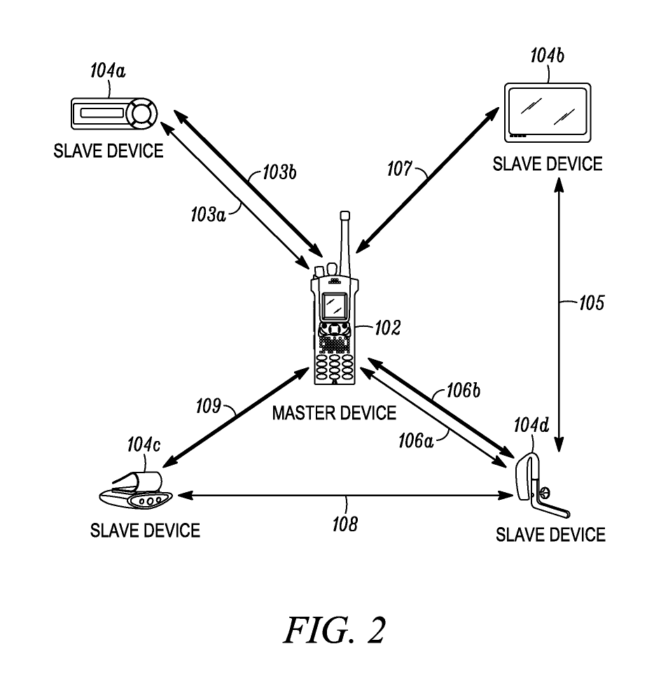

FIG. 2 is a block diagram of a configuration of a paired communication devices in accordance with some embodiments. A low frequency transaction request is sent from the transceiver on slave device 104a to the touch-point on master device 102, over a low frequency communications means, as shown by arrow 103a. After a low frequency exchange of pairing credentials that are required for the connection establishment is completed, a wide area secure wireless RF connection as shown by arrow 103b is established between master device 102 and slave device 104a. Master device 102 and slave device 104d also establish a wide area secure wireless connection in a similar manner, as shown by arrows 106a and 106b.

The transceivers on slave devices 104a and 104d remains active after they are paired with master device 102 so that slave devices 104a and 104d can assist in the pairing of additional slave devices with master device 102. When slave device 104d receives a low frequency transaction request from slave device 104b, as shown by arrow 105, the received low frequency packets are wrapped with a low frequency identifier and forwarded over wide area secure wireless RF connection 106b between master device 102 and slave device 104d. Master device 102, recognizing the low frequency data wrapper, forms a low frequency reply, wraps it with the low frequency identifier, and returns a low frequency reply to slave device 104d via the wide area secure wireless RF connection 106b. Slave device 104d forwards the low frequency reply from master device 102 to slave device 104b via low frequency link 105.

Upon completing the exchange of pairing credentials that are required for the wide area secure wireless connection establishment, a separate and direct wide area secure wireless RF connection, as shown by arrow 107, which may be for example a Bluetooth connection, is established between master device 102 and slave device 104b. Slave device 104d also assists in the pairing of master device 102 and slave device 104c in a similar manner. Accordingly, using low frequency link 108, a separate wide area secure wireless RF connection, as shown by arrow 109, is arranged and established between master device 102 and slave device 104c.

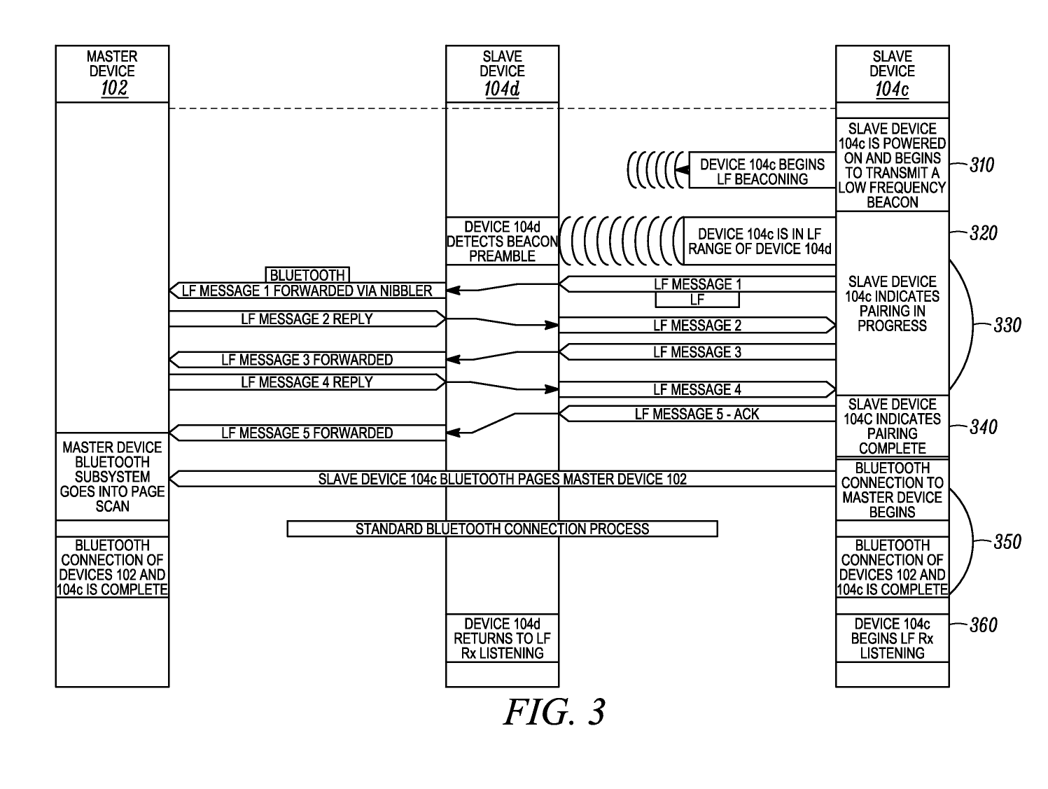

FIG. 3 is a message sequence chart illustrating the operation of a first slave device assisting in the pairing of a second slave device with a master device in accordance with some embodiments. Initially, master device 102 is on and has an active and secure Bluetooth connection with slave device 104d. Slave device 104d is configured to listen for low frequency transaction requests from other slave devices and slave device 104c is initially in the off state. In 310, slave device 104c is powered on and begins to repetitively transmit a low frequency transaction request, denoted “beaconing” in 310. In 320, when slave device 104c is within low frequency communications range of slave device 104d, slave device104d detects the transaction request from slave device 104c. In 330, when slave device 104d receives low frequency transmissions from slave device 104c, the received low frequency packets are wrapped with a low frequency identifier and forwarded over a secure Bluetooth link between master device 102 and slave device 104d. In particular, slave device 104d forwards a low frequency message (LF message 1) to master device 102 over the secure Bluetooth link between master device 102 and slave device 104d and master device 102 returns a wrapped low frequency reply (LF message 2 reply) to slave device 104c through the Bluetooth link. Slave device 104d unwraps and forwards the LF message 2 reply to slave device 104c via low frequency transmission to slave device 104c. Slave device 104c responds by sending a low frequency message (LF message 3) to slave device 104d. Slave device 104d wraps and forwards LF message 3 to master device 102 over the secure Bluetooth link between master device 102 and slave device 104d. Master device 102 returns a low frequency reply (LF message 4 reply) to slave device 104c through the Bluetooth link. Slave device 104d forwards the LF message 4 reply to slave device 104c by sending a low frequency transmission to slave device 104c.

Upon successfully exchanging pairing credentials through the low frequency messages sent between slave device 104c and master device 102, in 340, slave device 104c indicates that pairing is complete by sending a low frequency acknowledgement message (LF message 5 ACK) to slave device 104d. Slave device 104d forwards LF message 5 ACK to master device 102 over the secure Bluetooth link between master device 102 and slave device 104d. In 350, a Bluetooth component in slave device 104c pages master device 102 directly and the standard Bluetooth connection process occurs. In 360, upon successfully establishing a secure Bluetooth data link with master device 102, slave devices 104d and 104c return to listening for low frequency transaction requests from other slave devices.

Some embodiments may include a “stitching” device, i.e., a slave device whose sole function is to pair other low frequency enabled devices with the master device. The stitching device would first touch the master device and form a wide area secure wireless data communications link with the master device. Thereafter, the stitching device would be used to touch other slave devices at their touch-points to add the other slave devices to the network. Therefore, if the master device is in a location that is not well monitored or secured, the master device's low frequency transceiver could be turned off after the first link is formed. Subsequent slave devices paired with the master device would then be connected by touching the stitching device which would presumably be physically secure and more accessible than the master device.

Embodiments disclosed herein therefore enable the low frequency transceivers on slave devices to remain active after the slave device is paired with the master device. Each slave device includes means for wrapping/unwrapping low frequency messages, sent to and received from the master device, with headers indicating the messages are low frequency messages and the device from which the low frequency messages originated. Each slave device is configured to serve as a repeater/forwarder, wherein the slave device forwards the low frequency messages included in the data wrappers over a secure data communication link with the master device. Each slave device is also configured to service remote low frequency messages transmitted from the master device, wherein the master device is enabled in its role to enforce the security policy of the system. The low frequency pairing process may therefore be completed via exchanging low frequency messages with an already connected slave device, instead of requiring the low frequency exchange to occur directly with the master device. By enabling a new slave device to directly establish a wide area secure wireless data connection with the master device after pairing credentials are exchanged through low frequency messages, embodiments provide novel means of enhancing ease of pairing more than two slave devices with a master device, using low frequency touch pairing.

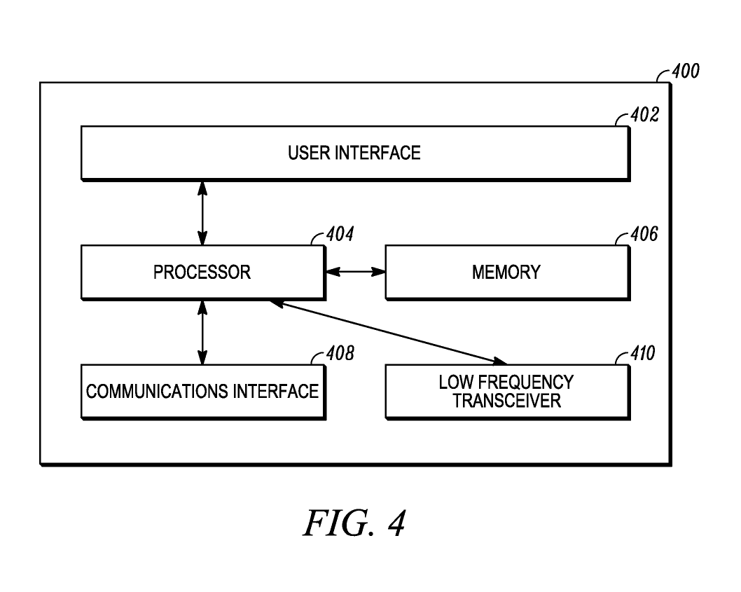

FIG. 4 is a block diagram which illustrates components of a master device used in accordance with some embodiments. According to an embodiment of the present invention the master device 400 includes a processor 404 to control operating features of the master device; a memory 406 to store, for example, data and computer program code components; and a wireless networking communication interface 408 which enables the master device to communicate wirelessly with other devices, and a low frequency transceiver 410. The master device may also include a user interface 402 such as a keypad, display or touch sensor. The user interface 402, memory 406, communication interface 408 and transceiver 410 are each operatively connected to the processor 404. Those skilled in the art will appreciate that the memory 406 may include various types of memory such as a random access memory (e.g., static random access memory (SRAM)), read only memory (e.g., programmable read only memory (PROM)), electrically erasable programmable read only memory (EPROM), or hybrid memory (e.g., FLASH), as is well known in the art. The processor 404 accesses a computer useable medium in the memory 406, which medium includes computer readable program code components configured to cause the master device to execute the functions described herein.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of pairing more than one slave device to a master device through an exchange of low frequency messages between the slave devices and the master device, the method comprising:
establishing a first secure data connection between a first slave device and the master device;
maintaining an active, low frequency transceiver, by the first slave device, for receiving low frequency transaction requests from other slave devices; and
upon receipt of a low frequency transaction request from a second slave device, forwarding, by the first slave device, low frequency transmissions between the second slave device and the master device to facilitate in exchanging pairing credentials associated with establishment of a second secure data connection,
wherein upon successfully completing the exchange of pairing credentials associated with the second secure data connection, the second secure data connection is established between the second slave device and the master device.

2. The method of claim 1, wherein the forwarding comprises wrapping, by the first slave device, low frequency packets received from the second slave device with an identifier prior to forwarding the low frequency packets to the master device.

3. The method of claim 2, wherein the forwarding comprises sending, by the first slave device to the master device, the low frequency packets received from the second slave device over the first secure data connection.

4. The method of claim 1, wherein the forwarding comprises sending, by the first slave device, low frequency reply packets received from the master device over the first secure data connection to the second slave device via the active, low frequency transceiver.

5. The method of claim 1, wherein the receiving low frequency transaction requests comprises receiving low frequency requests transmitted from other slave devices to be paired with the master device.

6. A slave device configured to be paired with a master device through an exchange of low frequency messages between the slave device and the master device, the slave device comprising:
a low frequency transceiver configured to transmit and receive low frequency messages; and
a processor configured to process the low frequency messages;
wherein upon successfully exchanging low frequency messages conveying pairing credentials with the master device, the slave device is configured to establish a first secure data connection with the master device,
wherein after establishing the first secure data connection, the slave device is configured to keep the low frequency transceiver active, and
wherein upon receipt of a low frequency transaction request from a second slave device, the slave device is configured to utilize the first secure data connection to the master to act as a proxy between the second slave device and the master device to facilitate in exchange of pairing credentials associated with establishment of a second secure data connection between the second slave device and the master device.

7. The slave device of claim 6, wherein the processor is configured to wrap low frequency packets received from the second slave device with an identifier prior to forwarding the low frequency packets to the master device.

8. The slave device of claim 7, wherein the low frequency transceiver is configured to receive the low frequency packets sent from the second slave device, and the processor is configured to wrap the received low frequency packets before transmission of the low frequency packets to the master device over the first secure data connection.

9. The slave device of claim 6, wherein the low frequency transceiver is configured to receive wrapped low frequency reply packets from the master device over the first secure data connection, the processor is configured to unwrap the low frequency reply packets, and the low frequency transceiver is configured to send the low frequency reply packets to the second slave device.

10. The slave device of claim 6, wherein, in remaining active, the low frequency transceiver is configured to receive low frequency transmissions from other slave devices to be paired with the master device.

11. A master device configured to be paired with more than one slave device through an exchange of low frequency messages between each slave device and the master device, the master device comprising:
a low frequency transceiver configured to transmit and receive low frequency messages; and
a processor for processing the low frequency messages;
wherein upon successfully exchanging low frequency messages conveying pairing credentials with a first slave device, the master device is configured to establish a first secure data connection with the first slave device,
wherein the master device is further configured to receive low frequency messages from a second slave device, wherein the low frequency messages are forwarded by the first slave device through the first secure data connection,
wherein the master device is configured to exchange, through the first secure data connection with the first slave device, pairing credentials associated with establishment of a second secure data connection between the second slave device and the master device, and
wherein upon successfully exchanging low frequency messages conveying pairing credentials with the second slave device, the master device is configured to establish the second secure data connection with the second slave device.

12. The master device of claim 11, wherein the processor is configured to determine that a secure connection is to be established with each slave device.

13. The master device of claim 11, wherein the processor is configured to identify low frequency messages from the second slave device according to a data wrapper formatted around the low frequency messages received from the first slave device.

14. The master device of claim 13, wherein the processor is configured to form a reply message to the low frequency messages transmitted from the second slave device and to wrap the reply message in a low frequency data wrapper, wherein the reply message is transmitted to the second slave device through the first slave device.

15. The master device of claim 14, wherein the low frequency transceiver is configured to transmit the reply message to the first slave device through the first secure data connection.

16. The master device of claim 11, wherein the processor is configured to wrap low frequency packets created as reply to the second slave device with an identifier prior to forwarding the low frequency packets to the second slave device.
